(19) United States
(12) Patent Application Publication
(10) Pub. No.: US 2012/0163695 A1
(43) Pub. Date: Jun. 28, 2012

(54) INTRA-DETECTOR SCATTER CORRECTION

(75) Inventors: Forrest Frank Hopkins, Cohoes, NY (US); Clifford Bueno, Clifton Park, NY (US)

(73) Assignee: GENERAL ELECTRIC COMPANY, Schenectady, NY (US)

(21) Appl. No.: 12/975,543

(22) Filed: Dec. 22, 2010

(51) Int. Cl. G06K 9/00

(52) U.S. Cl. 382/132

(57) ABSTRACT

Intra-detector scatter correction methods to improve X-ray images. The method of correcting an X-ray image includes: receiving an original two-dimensional X-ray image; calculating a theoretical scattered image for a array of detector pixels by generating a theoretical point spread (TPS) function of a single pixel for a single line array of detector pixels, based on a system parameter; aggregating the TPS function into a full rotation of line arrays, so as to generating a TPS function for a 2-dimensional array of pixels; and applying the TPS function for a 2-dimensional array of pixels to a plurality of pixels in the detector; and then subtracting the theoretical scattered image from the original two-dimensional X-ray image, so as to create an improved X-ray image.

### STATEMENT REGARDING FEDERALLY SPONSORED DEVELOPMENT

This invention was made with government support under Contract No. HSHQDC-07-C-00036, awarded by United States Department of Homeland Security. The United States Government has certain rights in the invention.

### BACKGROUND OF THE INVENTION

The present invention relates generally to X-ray imaging and more particularly to an intra-detector scatter correction methodology.

In two-dimensional X-ray images, distortion is encountered due to intra-detector scatter contributions, commonly known as undercut, blooming, or blurring. Virtually all such images exhibit some degree of distortion due to this effect. The amount of distortion may vary depending on X-ray energies, sizes, types of area detectors, and the like. Such distortion can reduce the visibility, detectability, and accurate characterization of features, such as their shape and opacity, within the image. In addition to compromising the accuracy of the representation of such features in a single image, the distortion can be magnified where several such images are used in a backprojection process to produce three-dimensional image sets (e.g., images produced in CT or laminographic systems).

Accordingly, there is an ongoing need for improving upon X-ray images.

### BRIEF DESCRIPTION

The present invention overcomes at least some of the aforementioned drawbacks by providing a two-dimensional image, or in the case of CT or laminography a three-dimensional image set, that is a more accurate representation of the geometry and opacity of features within the object being imaged with X-rays. More specifically, the present invention is directed to methodologies of improving X-ray images. Ultimately, aspects of the present invention obtain an improved imaging performance of the X-ray imaging system.

Therefore, in accordance with one aspect of the invention, a method of correcting an X-ray image comprises: receiving an original two-dimensional X-ray image; calculating a theoretical scattered image for a array of detector pixels, wherein the calculating comprises: generating a theoretical point spread function of a single pixel for a single line array of detector pixels, based on a system parameter; aggregating the theoretical point spread function into a full rotation of line arrays, thereby generating a theoretical point spread function for a 2-dimensional array of pixels; and applying the theoretical point spread function for a 2-dimensional array of pixels to a plurality of pixels in the detector; and subtracting the theoretical scattered image from the original two-dimensional X-ray image, thereby creating an improved X-ray image.

In accordance with another aspect of the invention, a method of improving an X-ray image comprises removing a theoretical scattered image from an original two-dimensional X-ray image, thereby generating an improved X-ray image, wherein the theoretical scattered image is calculated comprising: generating a theoretical point spread function by running a Monte Carlo model for a single line array of detector pixels, based on a system parameter; setting a value of a center point pixel in the theoretical point spread function to zero; aggregating the theoretical point spread function into a full rotation of line arrays, thereby generating a theoretical point spread function for a 2-dimensional array of pixels; and applying the theoretical point spread function for the 2-dimensional array of pixels to a plurality of pixels in the detector; and displaying the improved X-ray image.

Various other features and advantages of the present invention will be made apparent from the following detailed description and the drawings.

### BRIEF DESCRIPTION OF THE DRAWINGS

The drawings illustrate one embodiment presently contemplated for carrying out the invention.

FIG. 1 is a schematic view of an X-ray system, incorporating aspects of the present invention.

FIG. 2 is a cross-sectional elevation view of a portion of an X-ray detector, in accordance with aspects of the present invention.

FIG. 3 is a close-up schematic view of a portion of a pixelized X-ray detector, in accordance with aspects of the present invention.

FIG. 4A is a close-up schematic view of a portion of an X-ray detector undergoing the phenomenon of intra-detector scatter correction, in accordance with aspects of the present invention.

FIG. 4B is a close-up schematic view of a larger portion of an X-ray detector in FIG. 4A, undergoing the phenomenon of intra-detector scatter correction, in accordance with aspects of the present invention.

FIG. 5A depicts a graph of the energy deposition signal vs. pixel location for one axis of a modeled point spread function, in accordance with aspects of the present invention.

FIG. 5B is an illustration of the two dimensional PSF function derived from rotating the single axis PSF in FIG. 5A about the central pixel (with the central value set to 0), in accordance with aspects of the present invention.

FIG. 6A depicts an original X-ray image of a steel step-wedge.

FIG. 6B depicts a theoretical scattered image of the steel step-wedge after application of a point spread function, in accordance with aspects of the present invention.

FIG. 6C depicts an improved X-ray image of the steel step-wedge after subtracting the theoretical scattered image in FIG. 6B from the original X-ray image in FIG. 6A, in accordance with aspects of the invention.

FIG. 7A depicts a graph of a vertical profile of pixel location vs. signal level with and without intra-detector scatter correction for the steel step-wedge in FIGS. 6A and 6C, in accordance with aspects of the present invention.

FIG. 7B depicts a graph of a horizontal profile of pixel location vs. signal level with and without intra-detector scatter correction for the steel step-wedge in FIGS. 6A and 6C, in accordance with aspects of the present invention.

### DETAILED DESCRIPTION

Aspects of the present invention involve the determination and removal of the contribution to an X-ray area detector signal originating from scattering within the detecting medium (e.g., a scintillator material in a scintillation detector). This contribution is referred to as intra-detector-scattering (IDS). In a scintillator, IDS consists of both X-ray and optical scattering, among other effects. Removing it can be referred to as scatter-corrected or IDS-corrected. This correction process is based on the generation of a two-dimensional point spread function (PSF) for an X-ray detector response. The PSF can be obtained either by measurement or by theoretical modeling (simulation) of the processes involved. In the case of a scintillation detector, and depending on X-ray energy and detector material, the PSF may be dominated by the X-ray scattering, the optical scattering, or significant contributions from both. It is determined largely in high energy (e.g., greater than 1 MeV) imaging by X-ray scattering within the detection medium, and the deconvolution of that function from images produced with the detector. The generation of that PSF can be achieved in a number of ways, including Monte Carlo modeling of the detection process or measurement of the function by means of an appropriately configured imaging system. The removal of the IDS component in an area image restores the signal levels corresponding to the originally detected x rays, which can improve both the spatial resolution of the image and the accuracy of the detected X-rays (a signature of the degree of attenuation encountered during penetration of the object being imaged).

IDS may be one of the larges factors affecting image quality, and impacts artificial shading, and edge definition. For some high energy megavolt imaging cases, this secondary scatter within the detector can add as much as approximately 2× the signal level above and beyond the primary signal in a given pixel. This added signal level is not useful to the practitioner, as it does not provide any added information content. In fact, the added signal level adds an offset to the signals that do provide information content; and, thus, creates erroneous contrast levels in an X-ray scene.

Aspects of the present invention may comprise: (1) modeling of a two-dimensional point spread function (PSF) for a specific detector configuration and X-ray spectrum; (2) application of the PSF to the original image (itself adjusted by an initial approximation of the true signal level in several relevant regions) and generation of an image corresponding to the contributions from the IDS; and (3) subtraction of the IDS scatter image from the original image to produce the scatter-corrected, or improved, image.

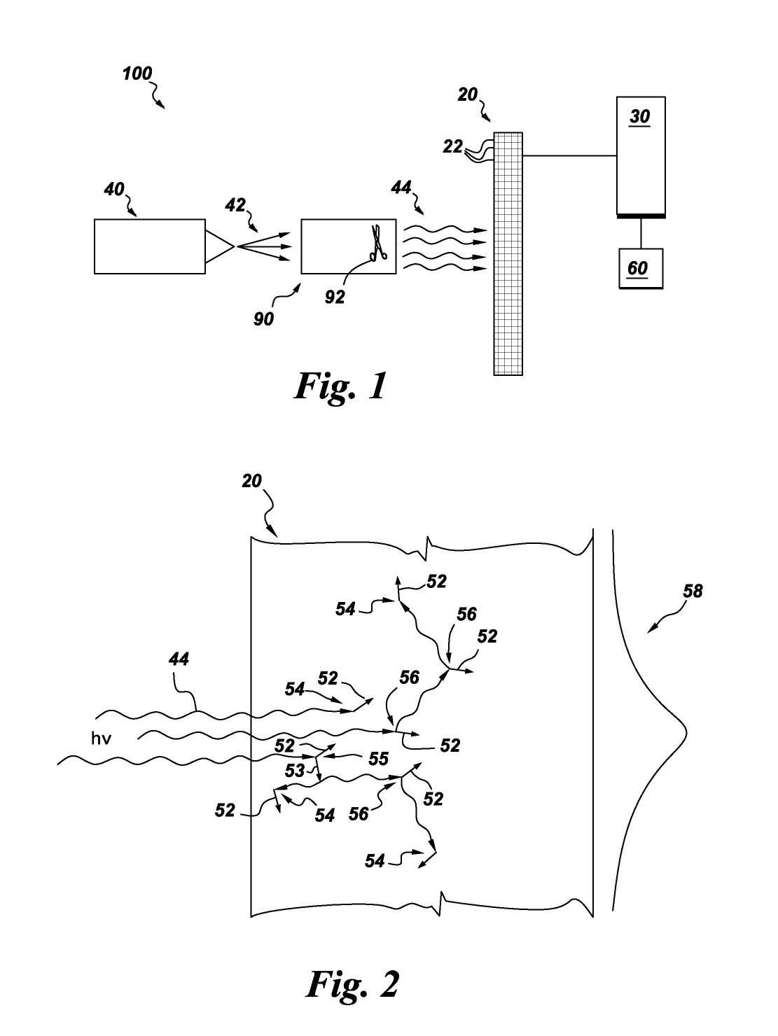

Referring to FIG. 1 a schematic view of an X-ray system 100 is depicted. The X-ray system, or system 100 includes at least one X-ray source 40 that is configured to emit X-rays 42. An object 90 that may or may not have a region or item of interest 92 therein is located between the X-ray source 40 and a scintillator 20. As is known, the X-rays 42 are emitted towards the object 90, while a portion of the X-rays 44 pass through the object 90 (and/or object of interest 92) so as to reach the scintillator 20. The scintillator 20 includes an array of a plurality of detector pixels 22. The detector pixels 22 of the scintillator 20 convert the impinging X-rays 44 to light photons. The light photons are transmitted to a photo conversion device 30 where the light photons are converted to signals at circuit 60. Ultimately, as is known, the location and strength of the X-rays 44 that reach the scintillator 20 are what dictate the X-ray image that is ultimately created by the system 100.

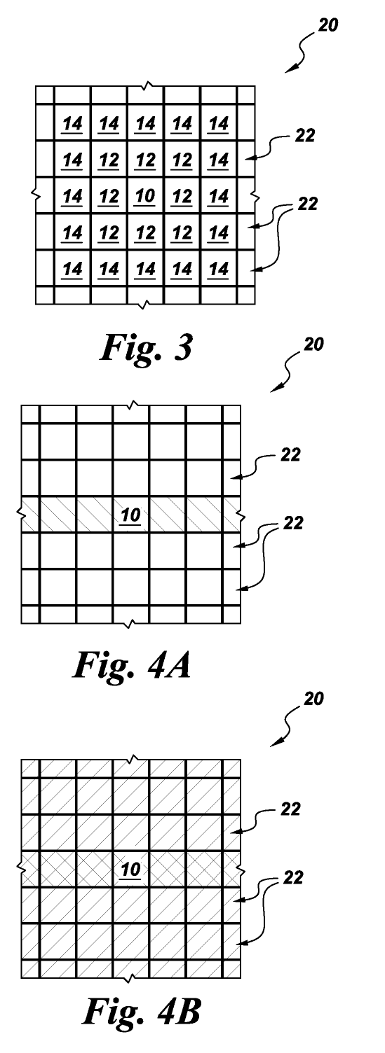

Referring to FIG. 2, a cross-sectional close-up elevation of a portion of a scintillator 20 is depicted. An X-ray 44, having passed through at least a portion of the object 90 (FIG. 1) and/or avoiding the object 90 altogether, and impinges upon the scintillator 20 that is beyond the object 90. As shown within the scintillator, the X-ray 44 (i.e., primary X-rays) is/are scattered or dispersed and converted in various ways in the scintillator 20. For example, the X-ray 44 is scattered in various locations, via Compton scattering 56, creating recoil electrons 52. The resulting scattered X-rays and electrons 52 further scatter. In other locations, the X-ray 44 and/or secondary X-rays are converted to electrons 52 via photoelectric absorption 54. Similarly, as shown at 55, at other locations X-ray 44 (and/or scattered X-rays) are converted, via pair production, into an electron 52 and a positron 53 that annihilate to form 511 keV X-ray photons that can then cascade in energy as mentioned above. Ultimately, the cascading of energy from the primary X-ray 44, within the scintillator 20, produces a wider distribution of energy deposition and concomitant emission of light than the localized region of the incident primary X-ray 44 that is further processed by an X-ray system 100 (FIG. 1). The curve 58 indicates a typical distribution of light exiting the scintillator 20. It has been discovered that in particular for high energy X-ray cases, for scintillator or direct conversion detectors, that the scatter of the X-ray photons due to Compton scattering is the dominant mechanism producing the distribution curve 58. It should be apparent to one of skill, that while FIG. 2 merely depicts a single or small number of theoretical X-ray beams and the concomitant electrons, scattered X-rays, and light photons, this phenomena is occurring with a plurality of X-ray beams all impinging on a scintillator material. This scatter produced from each beam ultimately effects adjacent and/or nearby detector pixels, thereby effecting the ultimate X-ray image that is generated. Aspects of the invention attempt to address and mitigate the effects of the scatter between detector pixels.

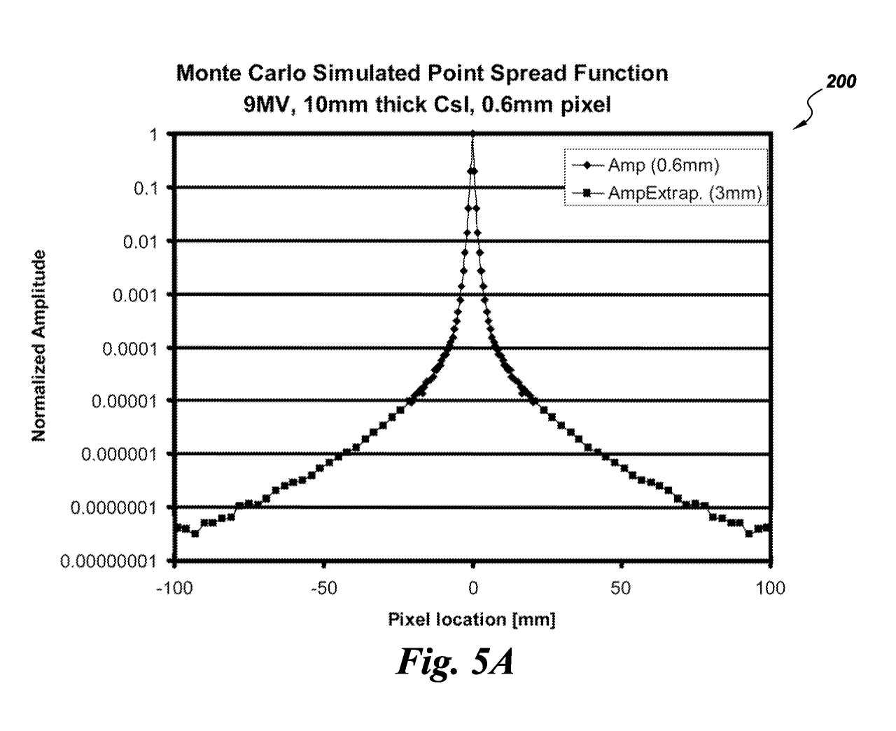

Referring to FIG. 3 a close-up plan view of a portion of a scintillator 20 is depicted. The view is shown for reference purposes. The scintillator 20 comprises a plurality of pixels 22 arranged in an array. A single central pixel, will be designated as a target pixel 10. As shown, immediately adjacent to the target pixel 10 are eight (8) adjacent pixels 12. Moving further outward from the target pixel 10 is a next annulus of sixteen (16) pixels 14. The listed pixels 10, 12, 14 are shown merely for reference. Based on the aforementioned scatter, it should be apparent that, taking the target pixel 10 as the reference pixel, or point, that scatter from the target pixel 10 would effect the signal (and, therefore, ultimately, image accuracy) that is generated by the closest adjacent pixels 12. Similarly, the scatter from the target pixel 10 would next most effect the next annulus pixels 16, and so forth. Clearly, the further a particular pixel is from the target pixel 10, the less effect that scatter from the target pixel 10 has on that particular pixel.

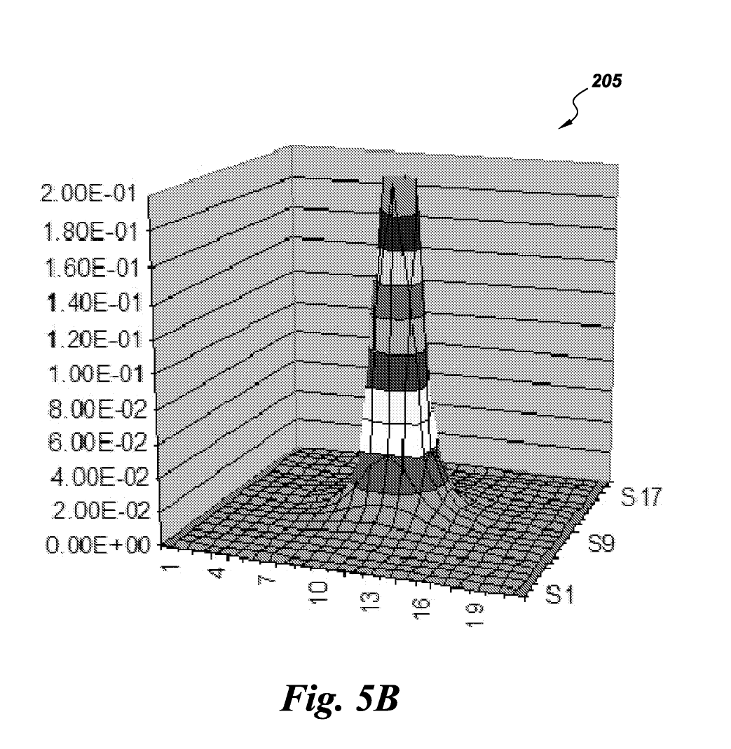

Aspects of the present invention comprise calculating a theoretical scattered image for an array of detector pixels. As such, a first step is to generate a theoretical point spread function of a single, target pixel 10 for a single line of pixels extending from the target pixel 10, as shown FIG. 4A. To generate the theoretical point spread function a Monte Carlo model may be run on an event-by-event basis to produce the scattering distribution and resulting energy deposition distribution (point spread function) for a line of pixels based on a specific set of system geometry and parameters. Any X-ray system parameter or combination of parameters may be used including, for example, a source type, a detector type, a detector setting, a source-to-detector distance, a thickness of a detector material, a detector pixel size, and the like. The modeling then produces the point-spread function specific for that particular system description.

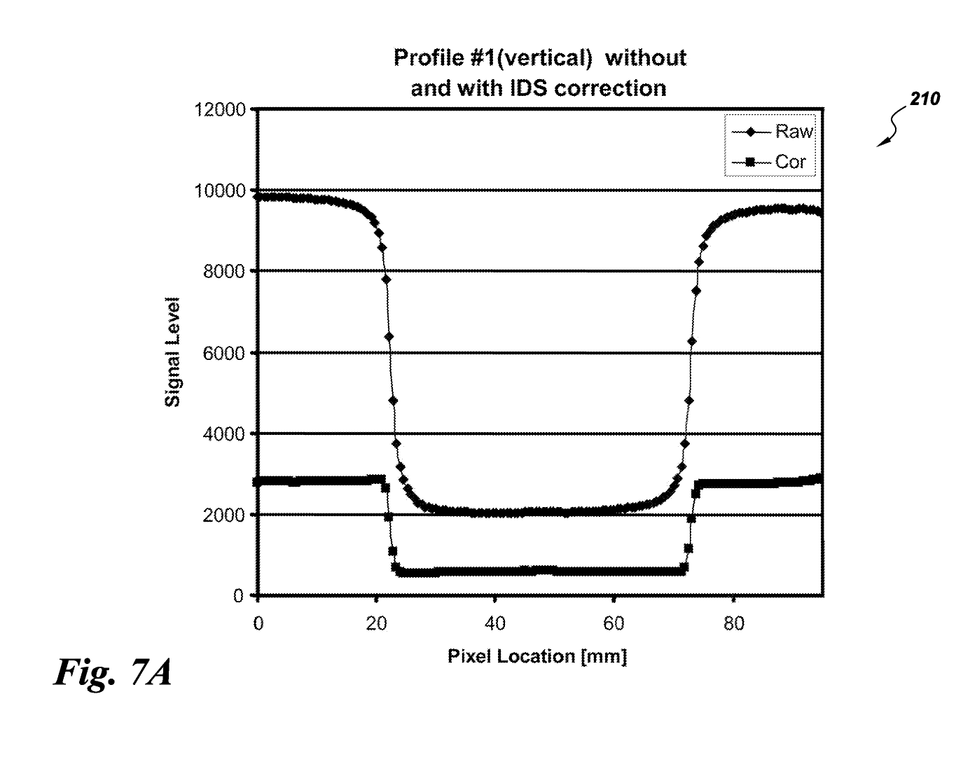

Then, as FIG. 4B depicts, the generated point-spread function for one axis or “slice” out of a full field-of-view for an area detector(s) is then “rotated”, or arithmetically duplicated through a full 360 degrees about the target pixel 10. Once the full (two-dimensional) theoretical point-spread function for the single, target pixel 10 is obtained, to the PSF, or kernel, is convolved with all the pixels in the device or devices to produce an image of the scatter. The PSF is applied after a normalization of the signal value of each pixel 22 to restore it approximately to a true signal level independent of scatter. A theoretical scattered image is thus calculated (See e.g., FIG. 6B).

As shown in FIG. 6C, for example, the generated scattered image is subtracted from the original or raw X-ray image, thereby created an improved X-ray image that has been corrected for intra-detector X-ray scatter.

While aspects of the present invention may bring benefit mostly to high energy X-ray systems, aspects of the present invention are not limited as such. The energy of an X-ray source(s) may be, for example, greater than about 450 KeV. In other embodiments, the energy of the X-ray source(s) may be above about 1 MV. In still other embodiments, the energy level of the X-ray source(s) may be about 9 MV or higher in voltage.

Similarly, if a scintillator-type detector is employed under aspects of the present invention, virtually any suitable scintillator material may be used. For example, target scintillating materials might include CsI:Tl, Gd₂O₂S:Tb, Lu₂O₃:Eu, a silicate-based scintillating glass, a ceramic segmented scintillator, and the like. The scintillating materials may be configured in different forms in relation to light capture by the pixelized receiver. Further the invention is not limited to scintillation materials only. Aspects of the present invention may be extended to suitable photoconductive detection media such as CdTe, ZnCdTe, GaAs, Se, PbI₂, and the like.

A signal collection device that may be used that employs scintillating material under aspects of the present invention includes, for example, a flat panel pizelized diode thin film transistor array, a CMOS imaging device, a CCD, and the like. The signal collection device may be coupled to said scintillator either by lens optics, fiber optics, or direct contact.

Contrastingly, a signal collection device may be used that employs photoconducting materials that do not produce light, but rather produce electrons and holes that are separated and then collected via a voltage bias to a read device of a pixelized electrode structure common to the industry of such “direct” conversion devices.

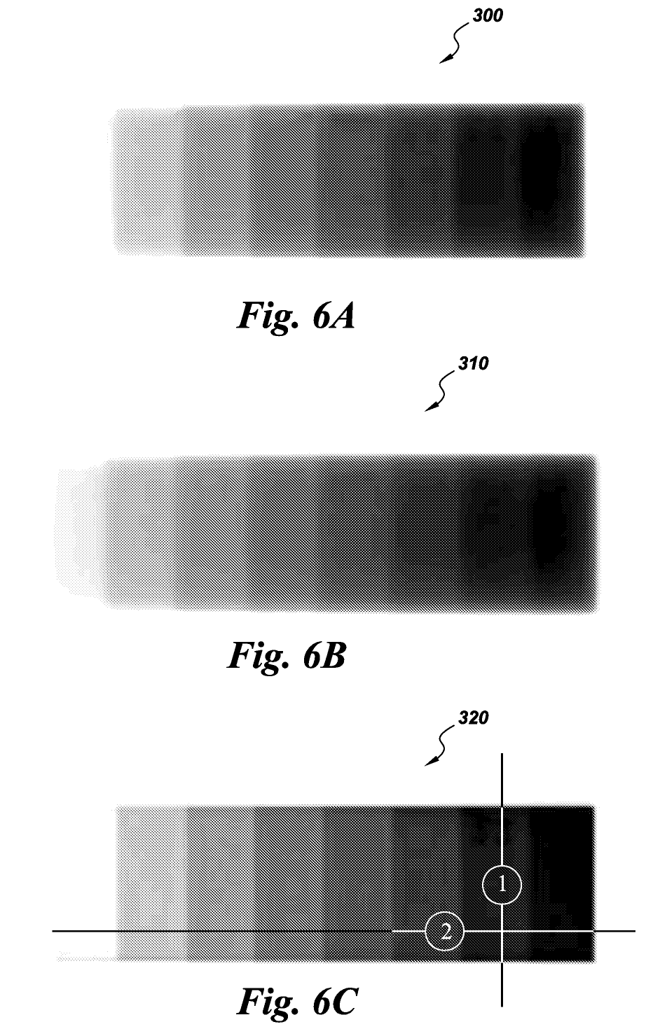

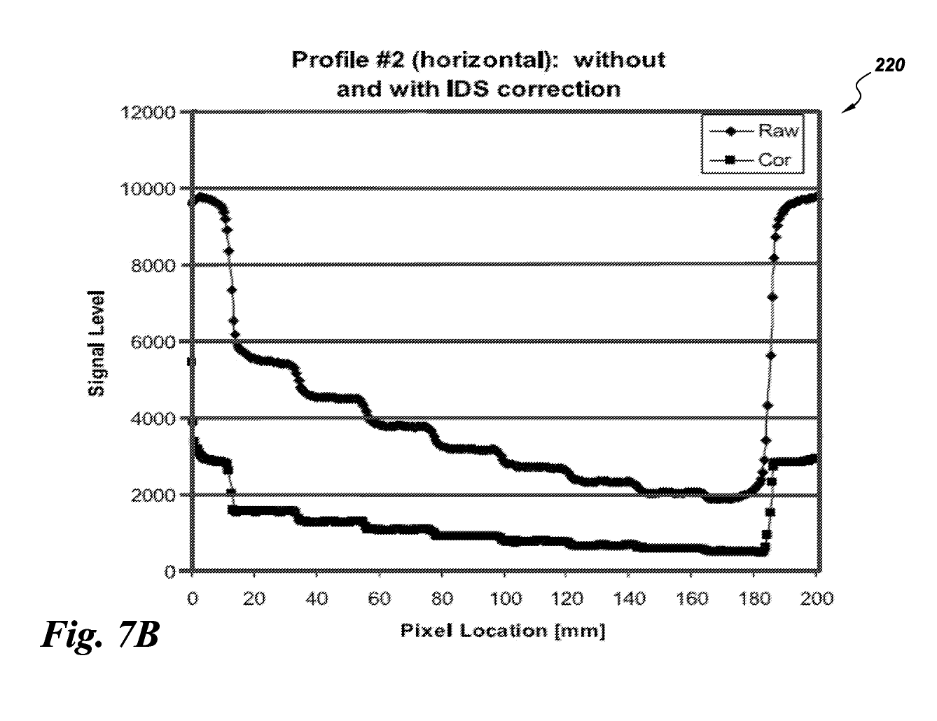

Referring in general to FIGS. 5A-5B, 6A-6C, and 7A-7B, data is shown for experiments conducted with a steel step wedge employing aspects of the present invention. The photon statistics for a line of scatter was modeled for a 9 MV beam upon entry into a 10-mm CsI scintillator having a 600-micron pitch. Given the time needed to model, a single line of pixels was modeled, as shown in the point spread function depicted in FIG. 5A. The single line model was then arithmetically duplicated to a full 360 degrees about a target pixel. Thus, a kernel that is 301×301 is created that is used on all 600-micron pixels in the 682×340 pixel array (in this case, for the doublet detector 20-cm×40-cm device). An illustration of the central region of the two dimensional kernel is shown as 205 in FIG. 5B. The kernel is applied following a normalization of the signal value of each pixel due to approximate the true signal independent of the build-up of scatter. A theoretical scatter image is obtained, as shown in FIG. 6B. The scatter image (FIG. 6B) is subtracted from a raw X-ray image (FIG. 6A). A much flatter, more defined, improved X-ray image results, as shown in FIG. 6C. Profiles across the steel step wedge are provided showing the raw and the IDS-corrected signal level vs. pixel location in both a vertical profile (FIG. 7A) and a horizontal profile (FIG. 7B).

Several observations have been made in employing aspects of the present invention including that with applying the IDS correction, a drop in signal level approximately by a factor of 3, providing much lower background signals within the image, thus enhancing image contrast. Additionally, after IDS correction, the spatial resolution of the image is improved as evidenced by the clear, sharp definition of the edges of the wedge and the steps within the wedge. This improvement will therefore enhance detection through materials of significantly differing densities, where the impact of intra-detector scatter may have its highest effect on said edge definition. Referring to the correction of the stepwedge, each individual step is flat, enabling better quantification of material information without shading. In addition, the signal amplitudes for the different regions within the image are more accurate quantitatively, an important consequence when correlated processes are employed, such as the reconstruction backprojection which produces CT images. While it is noted that residual noise associated with the higher IDS signal level is still present in the same amount as the corrected image, the removal of the background affords these several benefits.

Aspects of the present invention may be applied with a system 100 such as that depicted in FIG. 1. However, as should be apparent to one skilled in the art, the invention is not limited to such a system. Virtually, any system that uses X-rays may benefit by applying the methods herein. For example, a traditional X-ray system that uses a scintillator material as a detector along with a photo conversion device may be used. Similarly, an X-ray system that uses a direct conversion type of detector may be used. Additionally, although methods of the present invention may be used with a new X-ray system, the methods herein may also be used with and to improve upon a pre-existing X-ray system. Similarly, being that aspects of the present invention comprise methods, the methods may be applied from a system (e.g., computer) that is remote from the X-ray system. For example, if the entity conducting aspects of the present invention obtained or received the requisite X-ray system parameters, the method or portions of the method could be conducted in a remote fashion from the X-ray system proper.

Therefore, according to one embodiment of the present invention, a method of correcting an X-ray image comprises: receiving an original two-dimensional X-ray image; calculating a theoretical scattered image for a array of detector pixels, wherein the calculating comprises: generating a theoretical point spread function of a single pixel for a single line array of detector pixels, based on a system parameter; aggregating the theoretical point spread function into a full rotation of line arrays, thereby generating a theoretical point spread function for a 2-dimensional array of pixels; and applying the theoretical point spread function for a 2-dimensional array of pixels to a plurality of pixels in the detector; and subtracting the theoretical scattered image from the original two-dimensional X-ray image, thereby creating an improved X-ray image.

According to another embodiment of the present invention, a method of improving an X-ray image comprises removing a theoretical scattered image from an original two-dimensional X-ray image, thereby generating an improved X-ray image, wherein the theoretical scattered image is calculated comprising: generating a theoretical point spread function by running a Monte Carlo model for a single line array of detector pixels, based on a system parameter; setting a value of a center point pixel in the theoretical point spread function to zero; aggregating the theoretical point spread function into a full rotation of line arrays, thereby generating a theoretical point spread function for a 2-dimensional array of pixels; and applying the theoretical point spread function for the 2-dimensional array of pixels to a plurality of pixels in the detector; and displaying the improved X-ray image.

The present invention has been described in terms of the preferred embodiment, and it is recognized that equivalents, alternatives, and modifications, aside from those expressly stated, are possible and within the scope of the appending claims.

What is claimed is:

1. A method of correcting an X-ray image comprising:
receiving an original two-dimensional X-ray image;
calculating a theoretical scattered image for an array of detector pixels, wherein the calculating comprises:
generating a theoretical point spread function of a single pixel for a single line array of detector pixels, based on a system parameter;
aggregating the theoretical point spread function into a full rotation of line arrays, thereby generating a theoretical point spread function for a 2-dimensional array of pixels; and
applying the theoretical point spread function for a 2-dimensional array of pixels to a plurality of pixels in the detector; and
subtracting the theoretical scattered image from the original two-dimensional X-ray image, thereby creating an improved X-ray image.

2. The method of claim 1 wherein the system parameter comprises at least one of a source type, a detector type, a detector setting, a detector pixel size, a source-to-detector distance, and a thickness of a detector material.

3. The method of claim 1, wherein an energy of a X-ray source that generated the original two-dimensional X-ray image is above about 450 KeV.

4. The method of claim 3, where the energy of the X-ray source that generated the original two-dimensional X-ray image is above about 1 MeV.

5. The method of claim 1, wherein X-rays that generated the original two-dimensional X-ray image impinge on a scintillator material, wherein the scintillator material comprises one of CsI:Tl, GD₂O₂S:Tb, Lu₂O₃:Eu, a silicate-based scintillating glass, and a ceramic segmented scintillator.

6. The method of claim 1, wherein the applying comprises applying the theoretical point spread function for a 2-dimensional array of pixels to all of the pixels in the detector.

7. The method of claim 1, further comprising generating the original two-dimensional X-ray image.

8. The method of claim 1, further comprising outputting the improved X-ray image.

9. The method of claim 8, the outputting comprising displaying the improved X-ray image.

10. The method of claim 1, wherein the aggregating further comprises setting a value of a center point pixel in the theoretical point spread function to zero.

11. The method of claim 1, wherein X-rays that generate the original two-dimensional X-ray image impinge on a photoconductive X-ray detection media, wherein the photoconductive X-ray detection media comprises one of CdTe, ZnCdTe, GaAs, Se, and PbI₂.

12. The method of claim 1, wherein the generating comprises running a Monte Carlo model for the single line array of detector pixels.

13. A method of improving an X-ray image comprising:
removing a theoretical scattered image from an original two-dimensional X-ray image, thereby generating an improved X-ray image, wherein the theoretical scattered image is calculated comprising:
generating a theoretical point spread function by running a Monte Carlo model for a single line array of detector pixels, based on a system parameter;
setting a value of a center point pixel in the theoretical point spread function to zero;
aggregating the theoretical point spread function into a full rotation of line arrays, thereby generating a theoretical point spread function for a 2-dimensional array of pixels; and
applying the theoretical point spread function for the 2-dimensional array of pixels to a plurality of pixels in the detector; and displaying the improved X-ray image.

14. The method of claim 13, wherein X-rays that generate the original two-dimensional X-ray image impinge on one of a scintillator material and a photoconductive X-ray detection media.
